(19) United States
(12) Patent Application Publication
(10) Pub. No.: US 2010/0175266 A1
(43) Pub. Date: Jul. 15, 2010

(54) CARTRIDGE TIP CUTTING DEVICE AND METHOD

(76) Inventor: Brett W. Fischer, Lee's Summit, MO (US)

Correspondence Address: INTELLECTUAL PROPERTY CENTER, LLC, 9233 WARD PARKWAY, SUITE 100, KANSAS CITY, MO, 64114, US

(21) Appl. No.: 12/377,792

(22) PCT Filed: Aug. 14, 2007
(86) PCT No.: PCT/US07/75922

§ 371 Date: Feb. 17, 2009

Related U.S. Application Data
(60) Provisional application No. 60/837,037, filed on Aug. 14, 2006.

(51) Int. Cl. B26B 27/00; B23D 21/10; B26B 29/06; B26D 3/16

(52) U.S. Cl. 30/92; 30/282; 30/298; 83/54

(57) ABSTRACT

The present invention provides a method for cutting the tapered tip of a cartridge, providing a cutler device with an angular guide adapted to receive the tapered tip through a tapered passage and cutting the tapered tip by operating the cutter between a withdrawn and deployed position. In general the cutting device includes a slide, an elongated structure having a top, bottom, proximate and distal ends and a channel adapted to receive the slide associated with the distal end. A guide associated with the elongated structure is adapted for receipt of the tapered tip and a reciprocating blade extending from the slide has a cutting edge which is adapted for engaging the tapered tip during operation of the cutter between deployed and withdrawn positions.

### CROSS-REFERENCE TO RELATED APPLICATION

This application claims the benefit of the prior filed U.S. provisional application No. 60/837,037 filed Aug. 14, 2006 which is incorporated herein: by reference.

### FIELD OF THE INVENTION

This invention relates to a device and method tor cutting a tip from a dispensing cartridge. More specifically, the invention provides an economic apparatus having a guide for receiving the tip of the dispensing cartridge and a reciprocating blade with a cutting edge for cutting the tip from the dispensing cartridge.

### BACKGROUND OF THE INVENTION

A caulk or other sealant is used to seal gaps and cracks in various structures. Sealant or the like may be commercial purchased in various cylindrical cartridges having a tapered tip extending axially from one end. These sealants and the like have various viscosities and properties suited for a variety of sealing applications or other interior improvements. These sealants are typically dispensed after removing or cutting the end of the cartridge tip.

Proper sealing of a structure can protect it from the weather, rain, snow, heat and undesired animals. Properly applied a sealant may last for twenty to fifty years. However, many applications of sealing fail early because of a non-uniform or incorrect head as a result of an improperly cut cartridge tip.

In a typical sealing application, the cartridge is inserted into a caulking gun and a portion of the tapered tip is cut using a variety of standard hand cutters such as pliers or knives. In this application, the resultant cut, may be irregular or vary substantially. Using the caulk gun, a head or stream of sealant is dispensed from the cut cartridge tip. The shape and cut of the tip therefore affects the amount, quantity and nature of the applied bead which in turn affects the quality of the sealed structure. An improper cut in the cartridge tip may result in an improper, or non-uniform bead or in a head which is too big or too little sealant for sealing the structure. It therefore would be beneficial to provide a technique and tool which provides a uniform flow of sealant for sealing the structure.

Various techniques and tools have been employed in the prior art to facilitate the cutting of tapered lips from cylindrical sealant cartridges. The application of sealant is primarily undertaken as a construction or maintenance procedure when a structure needs to be sealed.

In the general instance of joint sealing application, the current state of the art involves assembling a multiplicity of tools and the dexterous use thereof. Chief among the various tools used in the art are pliers, cutters including utility knives and various scrapers, spreaders and shapers. In operation, a user might use the knife blade to cut the tapered tip from the sealant cartridge, This process may be continued repetitively until a satisfactory result is achieved having a sufficiently tip configuration for the application of the sealant, or caulk bead. Alternatively, cutting the tapered tip with a plier may deform the tapered tip, resulting in an undesired bead. By providing a device with a smooth cut may prevent, deformation of the tapered tip, whereby the trailing edge of the tip while applying the bead to a joint may assist in shaping the extruded, caulk bead in the desired shape.

In addition, once the tip is cut and bead dispensed, the resultant bead may be to large, too small, or uneven and a spreader or shaper is needed to provide the proper material having the proper shape to the joint. Additionally, many jobs require multiple sealant cartridges to complete the sealing application.

The free-hand nature used to cut the cartridge tips practiced by the prior art may result in inconsistent and unsightly sealing of the structure allowing for non-uniform beads between plural cartridges resulting in unsightly bulges, failing or faulty sealing joints. Further, in as much as the average user may not be skilled in using the knife, spreader or shaper or providing a tip with proper characteristics, and where a variety in the nature of the adjacent surfaces to be sealed, and the types of caulking material applied requires the user to be experienced in the exercise and use of the various tools available in each unique application, it is not surprising that the quick and efficient removal of cartridge tips is rarely achieved. Moreover, inasmuch as the user often is not experienced in the above described cutting procedures which involve sharp tools, there is considerable opportunity for damage to be sustained upon persons or to the cartridge tip rendering the sealant cartridge unusable.

Many cartridge tip cutting tools are designed for different purposes, the cutting feature of the tool be a secondary or merely an additional non-primary purpose. For example, some prior art devices are primarily a sealant dispensing device or caulk gun, including a cutter within the trigger mechanism. Other prior art techniques include utilizing utility knives, pliers, or shears which may be used for many purposes not adapted for configuring the tip from the sealant cartridge. However, these prior art techniques and tools may not adequately remove the cartridge tip while providing for a proper shaped and sized tip having sufficient dimensions to dispense the sealant in a uniform, consistent manner with the proper shape and amount necessary to seal the structure.

Therefore, it is the opinion of the present inventor that the prior art is redolent with opportunity for failure by placing excessive demands upon the unskilled practitioner resulting in a failed sealing joint or worse a failing structure resulting from an improperly sealed joint. It would therefore be beneficial to provide a cartridge tip cutter which properly cut the tip of a cartridge, the cut tip resulting in a consistent, uniform bead, of sealant having proper dimensions for sealing a joint within a structure, the cartridge tip cutler, being ergonomic, easy to use or manufacture, and which is compact and convenient to carry tor transporting the cutter.

### SUMMARY OF THE INVENTION

The present invention reduces the difficulties and disadvantages of the prior art by providing a simple, cutting device and method for providing a consistent cut for dispensing sealant from a cut cartridge tip which is easy to use and can be manufactured for a relatively low cost. The present invention provides a method for cutting the tapered tip of a cartridge, providing a cutter device with an angular guide adapted to receive the tapered tip through a tapered passage and cutting the tapered tip by operating the cutter between a withdrawn and deployed position. In general the cutting device includes a slide, an elongated structure having a top, bottom, proximate and distal ends and a channel adapted to receive the slide associated with the distal end. A guide associated With the elongated structure is adapted for receipt of the tapered tip and a reciprocating blade extending from the slide has a cutting edge which is adapted for engaging the tapered tip during operation of the cutter between deployed and withdrawn positions.

### BRIEF DESCRIPTION OF THE DRAWINGS

FIG. 1 is a perspective view of the cartridge tip cutter in receipt of the tip of the sealant cartridge;

FIG. 2 is an exploded perspective view of the cartridge tip cutter illustrated in FIG. 1.

FIG. 3 is a perspective view of a top member of the cartridge tip cutter illustrated in FIG. 1

FIG. 4 is a perspective view of a bottom member of the cartridge tip cutter illustrated in FIG. 1.

FIG. 5 is a top plan view of the cartridge tip cutter slide and bottom member illustrated in FIG. 1.

FIG. 6 is a-top plan view of the cartridge tip cutter illustrated in FIG. 1.

FIG. 7 is a cross-sectional side profile of the cartridge tip cutter taken along line 7 in FIG. 6.

FIG. 8 is the bottom plan view of an alternative embodiment of the cartridge tip cutter.

### DETAILED DESCRIPTION OF THE INVENTION

### I. Introduction

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

### II. A Cartridge Tip Cutter

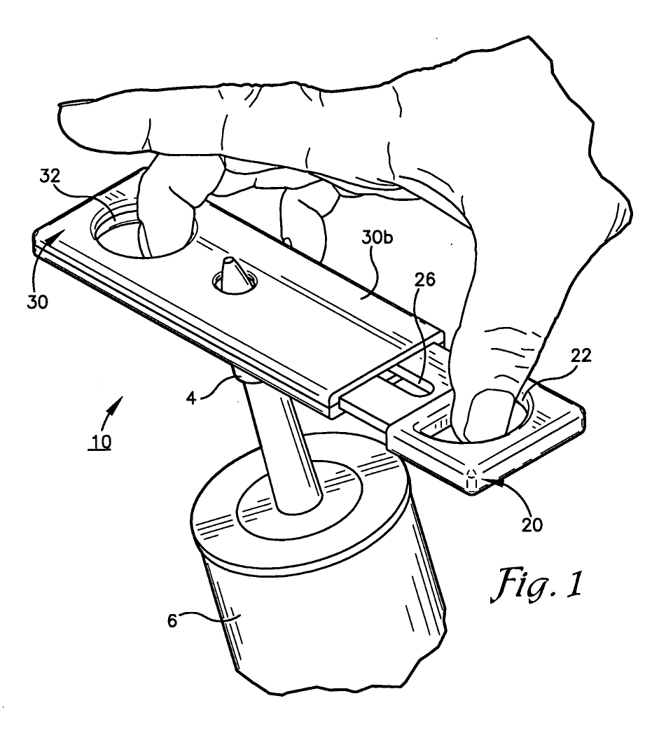

Referring to FIG. 1, an embodiment of the present invention a cartridge tip cutter is generally indicated by reference numeral 10, shown in association with a cartridge 6 having a tapered tip 4 which the cutter 10 is adapted to receive. Generally, the cutter 10 includes a slide 20, an elongated structure 30, a reciprocating blade 50 positioned between the slide 20 and elongated structure 30 and associated with a tapered guide 60, which extends upwardly from the cutter 10, the reciprocating blade 50 adapted for cutting the cartridge tip 4.

While the slide 20 and elongated structure 30 may include a variety of complementary shapes and con figurations, the embodiment illustrated in FIG. 1 depicts the cutter 10 having a rectangular configuration for easy storage and operation of the cutter 10. However, the cutter 10 may be alternatively configured with a variety of circular, triangular, regular of irregular shapes for cutting the tip 4 of the generally cylindrical cartridge 6. The slide 20 of FIG. 1 is illustrated with a first receiver 22 associated with a proximate end of the slide 20. A second receiver 32 is associated with the proximate end of the elongated structure 30 opposite the first receiver 22 of the slide 20.

Generally, the elongated structure 30 presents a channel 46 at the elongated structure's distal end, the channel 46 located between a top member 30a separated a distance from a bottom member 30b at the elongated structure's distal end, opposite the second receiver 32. While the channel 46 may have various configurations, in general it is adapted for frictional movement of the slide 20 within the elongated structure 30 during operation of the cutter 10. The slide 20 includes a longitudinal, centrally located slot or groove 26, employed for providing reciprocal longitudinal motion of the slide 20, the groove 26 having proximate and distal ends, the proximate end of the groove 26 being associated with the proximate end of the slide 20, while the distal end of the groove 26 is associated with the distal end of the slide 20. The groove 26 is also illustrated in FIG. 1, longitudinally extending from the proximate end of the slide 20 towards the distal end of the slide 20.

The illustrated first and second receivers 22, 32 are at least partially curved, although a number of alternative shaped receivers may be utilized in the present invention. Preferably, the receivers will allow for an ergonomic design and convenient two-fingered operation of the cutter 10. The first receiver 22, as illustrated in FIG. 1, is configured with a substantially semi-circular or D-shaped opening, while the second receiver 32 is optionally configured with a substantially circular opening. Optionally, the openings may be configured for receiving a thumb or finger allowing for manual operation of the cutter 10 between the withdrawn and deployed position. The cutter 10 peripheral edges may also be smoothed or radiused, providing a smooth, streamlined, visually appealing design.

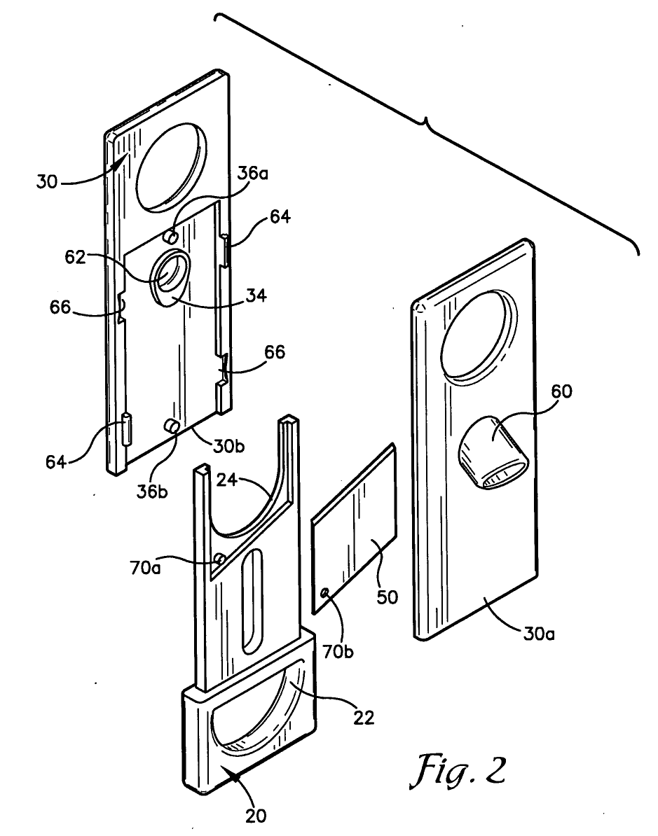

FIG. 2 illustrates the interior of the bottom member 30b including an upwardly extending spacer 34, first and second stops 36a, 36b linearly spaced along the interior of the bottom member 30. A tip aperture 62 extends through the bottom member 30b and is generally aligned with and in communication with the guide 60. A taper passage is formed within the combination of the guide 60 and tip aperture 62. The taper passage generally traverses the cutter 10 extending between the guide 60 and tip aperture 62, having a diameter adapted for receipt of the tapered tip. In general, the passage is adapted to receive the tapered tip 4 for cutting the tip 4 by extending the cutting edge 52 towards the proximate end of the elongated structure 30 within the channel 46.

Upon receipt, of the tapered tip 4 by the guide 60, the tip 4 may extend through the taper passage, the tip 4 positioned tor engagement by the cutting edge 52. Generally, the tip aperture 62 is circular, having a diameter which is at least as great as the narrowest portion of the tapered guide 60; however, the tip aperture 62 may also square or some other regular or irregular shape with a narrower diameter than the guide 60 depending on the cutting application.

The spacer 34, which encircles the tip aperture 62, is preferably elliptical or oval, however it may have a regular or irregular shape including but not limited to a circular or elliptical perimeter. As illustrated, the spacer 34 has narrow and broad ends, the broad end of the spacer 34 is generally associated with the proximate end of the elongated structure 30, while the narrow end of the spacer 34 is more, generally associated with the distal end of the elongated structure 30. The spacer 34 is generally positioned adjacent to at least one if not both the tapered guide 60 and tip aperture 62 and vertically aligns the cutting edge 52 of the reciprocating blade 50 for cutting the tip 4.

The cutter 10 may make one or more cuts of the tip 4 until the desired tip cut is achieved. Alternatively, the tapered guide 60 may be optionally configured with at least one interior radial collar (not shown), having a fixed diameter, spaced along the interior of the guide 60. As the tapered tip 4 extends along the taper passage, the collar allows the tip 4 to extend through the taper passage until the tip diameter exceeds the collar diameter, which allows the tip to be positioned for the desired cut. While supported by the collar, -the cutting edge 52 of the reciprocating blade 50 may engage the tapered tip 4. In this manner, a uniform cut of similar tips 4 may be provided by the cutter 10. Additional adjustments to the cut tapered tip 4 may be provided by rotating the bottom member 30b of the cutter 10 towards the tip 4, associating the cut tip 4 with the tip aperture 62. As the cutter 10 is operated the reciprocating blade 50 may be used to trim off excess material from the tip 4 until the desired cut is achieved.

The top member 30a is generally fastened, to the bottom member 30b using, for example, complementary configured and spaced snap connectors and snap receivers 64, 66. In FIG. 2, the snap connectors and receivers 64, 66 are illustrated, along the interior of the bottom member 30b. Alternatively, top and bottom members 30a, 30b may be fastened together with complementary spaced connectors 64 and/or receives 66, located along the exterior cutter perimeter or with conventional connectors such as but not limited to threaded fasteners, adhesives or the like.

The distal end of the elongated structure 30, presents the channel 46 positioned between the top and bottom members 30a, 30b. In general, the channel 46 receives the slide 20 and provides for reciprocal movement of the slide 20 within the elongated structure 30. As illustrated in FIG. 2 the first and second stops 36a, 36b extend. upwardly from the bottom member 30b into the channel 46. The second stop 36b is adapted for receipt by the groove 26, and allows linear movement of the slide 20 with respect to the elongated structure 30 during operation of the cutter 10. In addition, the second stop 36b allows for longitudinal movement of the first member 20, while inhibiting removal of the slide 20 from the elongated structure 30. Assembled, the first stop 36a is associated, with the proximate end of the elongated structure 30, while the second stop 36b is associated with the distal end of the elongated structure 30.

The proximate end of the slide 20 is shown with a first receiver 22 haying a generally rectangular outer peripheral surface and interior semi-circular opening, the first receiver 22 facilitating longitudinal movement of the slide, by an operator, during operation of the cutter 10. The distal end of the slide 20 also has a generally rectangular region extending from the first receiver 32, terminating at a rectangular depression 28 adapted for receiving the reciprocating blade 50 with cutting edge 52. The rectangular depression 28 may be perpendicular or parallel to the slide 20.

Preferably, the reciprocating blade 50 will be angled slightly, providing a leading and trailing region of the cutting edge 52. In comparison to a perpendicular blade arrangement, a leading and trailing cutting edge 52 way require less energy to cut the tapered tip 4 or alternatively, the cutter 10 may be used to cut larger or more rigid tapered tips 4. Angling the reciprocating blade 50 may therefore contribute to an unexpected and improved, cartridge tip cutter 10.

The reciprocating blade 50 is received within the rectangular depression 28 and integrated into the distal end of the slide 20, allowing for a level and true cut by the cutter 10 in relation to one or both of the tip aperture 62 and tapered guide 60. Securing structure 70 may optionally be provided for securing the reciprocating blade 50 to the slide 20 during operation. The securing structure 70 may include, but is not limited to, the illustrated fastener or pin 70a and fastener receiver or hole 70b, the fastener associated with the distal end of the slide 20 and adapted for receipt by said fastener receiver 70b positioned within said reciprocating blade 50. Another optional feature may include providing an arcuate window 24 below and adjacent to the rectangular depression 28, thereby limiting interference between the spacer 34 and slide 30.

In general, the guide 60 upwardly from the top member 30a. The illustrated tapered guide 60, has a generally frusto-cylindrical configuration with a lower and upper end, the lower end is generally positioned adjacent to and extends from the top member and the upper end has a generally circular opening. The circular opening extends through the guide for receipt of the tapered tip. Although the guides 60 orientation may vary, generally it is angled between 15 and 60 degrees from the axis perpendicular to the top member 30a. Although, the angle of orientation is fixed in the illustrated embodiment, if may be manufactured with a different angle orientation, with different guides or, alternatively, with an adjustable guide.

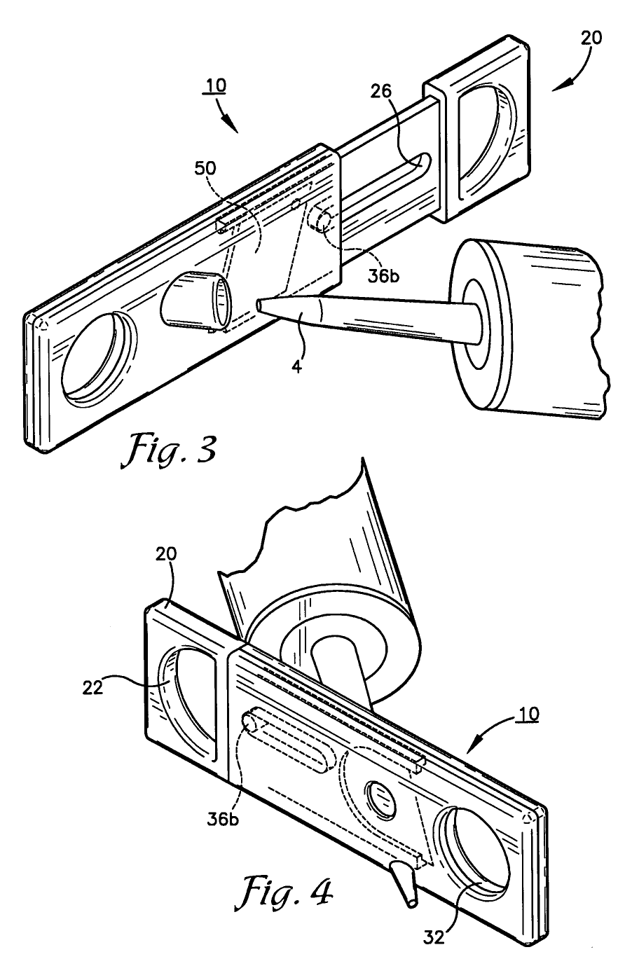

FIG. 3 illustrates the cutter 10 in a withdrawn cutter position for receipt of the tapered tip 4 with the slide 20 extended outwardly from the elongated structure 30. In the withdrawn cutter position, the distal end of the groove 26 is positioned near the second stop 36b, the reciprocating blade 50 being positioned within the channel 46, before the taper passage traversing the cutter 10. FIG. 4 illustrates the cutter 10 in a deployed cutter position with the slide 20 extended inwardly towards the second receiver 32. In the deployed cutter position, the reciprocating blade 50 traverses through the channel 46 through the taper passage towards the second slop 36b. In addition, in the deployed cutter position, the slide 20 is fully retracted within the channel 46, the outer perimeter of the cutter 10 having a generally rectangular shape with the first receiver 22 positioned near the distal end of the elongated structure 30.

The spacer 34 provides support for the reciprocating blade 50 during the operation of the cutter 10. The cutter 10 is illustrated in the withdrawn cutter position, in FIG. 5, with the slide 20 extended along the channel axially, outwardly from the second receiver 32. In the withdrawn cutter position, the cutting edge 52 of the reciprocating blade 50 is generally associated with the first or narrow end of the spacer 34. In the deployed position, the second or broader side of the spacer 34 is associated with the cutting edge. Although the spacer 34 may have various configurations, the elongated oval configuration depicted in FIG. 5 is preferred because is provides vertical support and vertically aligns the reciprocating blade 50 for intersection with the tip 4 at the taper passage near the lip aperture 62.

Snap connectors 64 and receivers 66 are also illustrated along the bottom member 30b, for receipt by complementary snaps and snap receivers (not shown) associated with the top member 30a. Alternatively, other generally known mechanical fasteners may be used to secure the top member 30a to the bottom member 30b.

While the reciprocating blade 50 may be orientated perpendicular to the channel 46, in FIG. 5, it is skewed for angular engagement between the cutting edge 52 and the tip 4 at the tip aperture 62. As illustrated, the cutting edge 52 extends from the reciprocating blade 50 towards the first stop 36a.

When the cutter 10 is in the deployed position, the cutting edge 52 may extend towards the first stop 36a, the spacer 34 providing vertical support for the reciprocating blade 52, The reciprocating blade 50 extends from and is secured to the slide 20 by the alignment structure 70 for reciprocal movement of the slide 20 within the channel 46 during alternating withdrawn and deployed cutter positions, in the deployed cutter position, the reciprocating blade 50 is generally extended towards the first stop 36a, the blade 50 separating the tapered guide 60 from the underlying tip aperture 62.

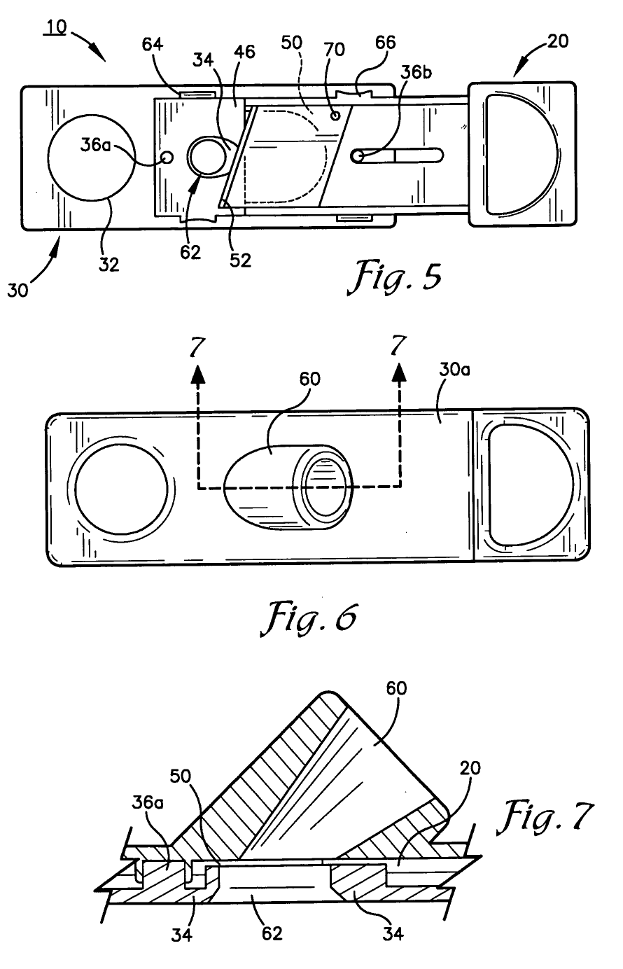

The top member 30a is illustrated in FIG. 6, with the tapered guide 60 angularly extending upwardly and away from the top member 30a. The angular orientation of the guide in the illustrated embodiment is generally fixed, tor consistent tip cuts and predictable sealant beads although the user may desire to repeat the cutting operation tor manual adjustment of the tip cut. Additionally, the user may desire to rotate the bottom member 30b towards the tapered tip 4 for additional manual adjustment of the tapered tip 4. The guide 60 has a generally tapered path from an opening having a generally larger internal diameter to a generally smaller internal diameter as the guide 60 extends towards the cutter 10.

FIG. 7 illustrates the cross section of the cutler 10 taken along line 7 in FIG. 6, in which the tapered guide 60 is generally aligned with the tip aperture 62. The cutting edge 52 of the blade 50 extends from the slide 20 towards the first stop 36a, the spacer 34, encircling the tip aperture 62, providing vertical support tor the blade 50. In the deployed cutter position, the blade 50 separates the guide 60 from the tip aperture 62. However, in the withdrawn position the tip aperture 62 is in communication with the tapered guide 60, presenting the taper passage through the cutter 10 for receipt of the tapered tip 4 therethrough.

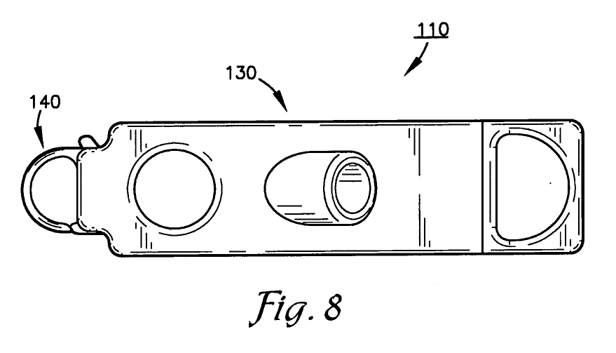

An alternative embodiment of the cutter 110 is illustrated in FIG. 8 including an alternative elongated structure 130 having a fastener 140 extending outwardly therefrom adapted for fastening the cutter 110 while not in use, for storing the device in a readily available location for ready retrieval of the cutter 110 or for receiving a key or other desired accessory.

In operation, the cutter 10 moves from the deployed position to the withdrawn position as the first and second receivers 22, 32 are extended outwardly for receipt by the cutter 10 of the tapered tip 4. The tapered tip 4 extending from one end of the sealant cartridge 6, is inserted into the cutter 10 through the tapered passage formed by the tapered guide 60 and tip aperture 62. The passage aligns the tip 4 in a fixed angular orientation in relation to the reciprocating blade 50, the tip 4 extending through the cutter 10 and out the cutter bottom member 30b. After the tip 4 is extended the desired distance through the bottom member 30b, the cutter 10 is reciprocally operated between the deployed and withdrawn cutter positions with the distal end of the slide 20 moving towards the proximate end of the elongated structure 30 along the channel 46 for engagement of the tip 4 by the cutting, edge 52 of the reciprocating blade 50. As the slide 20 continues to move longitudinally along the channel 46 towards the proximate end of the elongated structure 30, the tapered tip 4 is cut from the cartridge 6.

While the invention has been described with respect to specific examples including presently preferred modes of carrying out the invention, those skilled in the art will appreciate that there are numerous variations and permutations of the above described systems and techniques that tall within the spirit and scope of the invention as set forth in the appended claims.

1. A cutting device for cutting a tapered tip of a cartridge, the device comprising:
a slide;
an elongated structure having a top member, bottom member, proximate and distal ends, a channel adapted to receive said slide, presented at said distal end by said top member spaced from said bottom member;
a guide associated with said elongated structure adapted for receipt of the tapered tip; and
a reciprocating blade extending from said slide towards said proximate end, having & cutting edge, wherein the tip is cut by movement of said blade within said channel relative to said guide.

2. The cutting device of claim 1, said device further including:
a first receiver associated with said slide; and
a second receiver associated with said elongated structure, wherein said, cutter operates between an withdrawn and a deployed position as said first and second receivers are extended inwardly towards each other.

3. The cutting device of claim 2, wherein said first and second receivers have a thumb or finger opening for manual operation of the cutting device between the withdrawn and deployed positions.

4. The cutting device of claim 1, wherein said guide is a frusto-cylindrical guide with a lower and upper end, said lower end adjacent to said top member and said upper end having a circular opening extending therethrough, whereby said guide is adapted for receipt of the tapered tip.

5. The cutting device of claim 4 wherein said guide further includes an interior radial collar.

6. The cutting device of claim 1, further comprising:
a stop extending upwardly from said bottom member into said channel, and
a longitudinal slot associated with said slide receiving said stop for linear movement of said slide with respect to said elongated structure during operation of the cuffing device.

7. The cutting device of claim 1 wherein said bottom member further includes:
a spacer extending upwardly from said bottom member, and
a tip aperture extending through said bottom member and adapted to receive the tip, said spacer encircling said tip aperture, whereby said spacer aligns said cutting edge for cutting the received tip.

8. The cutting device of claim 7 wherein said spacer is elliptical having a first and second side, said first side associated with said cutting edge while said cutter is in the withdrawn position, said second side associated with said, cutting edge while said cutter is in the deployed position.

9. The cutting device of claim 1 further comprising:
a snap connector, extending upwardly from one of said, bottom arid top member, and
a complementary spaced snap receiver associated with die other of said bottom and top member, whereby said top member and said bottom member are secured for receiving said slide at said, distal end.

10. The cutting device of claim 1 further comprising:
a fastener associated with said slide, and:
a fastener receiver associated with said reciprocating blade whereby said reciprocating blade is secured to said slide during operation of the cutting device.

11. The cutting device of claim 10 further wherein said slide further includes a rectangular depression at a distal end of the slide said fastener extending upwardly from said rectangular depression for securing said reciprocating blade within said depression.

12. The cutting device of claim 1 wherein said reciprocating blade is skewed, presenting a leading and trailing cutting edge for cutting the tapered tip.

13. A cutting device for cutting a tapered lip of a cartridge, the device comprising:
a slide;
an elongated structure having a top member, bottom member, proximate and distal ends, a channel adapted to receive said slide presented at said distal end by said top member spaced from said bottom member;
a reciprocating blade having a cutting edge engaged by moving said slide relative to said channel, said blade extending from said slide towards said proximate end;
a guide extending from said top member having a circular opening opposite said top member;
a tip aperture in communication with said guide and extending through said bottom, member; and
a taper, passage formed within said guide and said tip aperture traversing said elongated structure, wherein said passage is adapted to receive said tip whereby said tip is cut by movement of said cutting edge within said channel relative to said guide.

14. A method for cutting the tapered tip of a cartridge including the steps of:
providing a cartridge tip cutting device having a first receiver associated with a slide, a second receiver associated with/an angular guide and an elongated structure presenting a channel atone end thereof opposite said second receiver, said angular guide extending outwardly from said elongated structure;
securing a reciprocating blade to said slide, received by said channel, said reciprocating blade having a cutting edge extending therefrom;
inserting the tapered tip into said cartridge tip cutting device through a tapered passage formed by said guide adapted for receipt of the cartridge tip, and
cutting said tapered tip by operating said cartridge tip cutting device at said first and second receivers between withdrawn and deployed positions by longitudinally extending said slide through said channel.
